(19) United States
(12) Patent Application Publication
(10) Pub. No.: US 2008/0204400 A1
(43) Pub. Date: Aug. 28, 2008

(54) DISPLAY DEVICE AND RECORDING MEDIUM STORING DISPLAY PROGRAM

(76) Inventor: Norihisa Fujii, Tokoname-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(21) Appl. No.: 12/057,354

(22) Filed: Mar. 27, 2008

Related U.S. Application Data
(63) Continuation-in-part of application No. PCT/JP2006/317536, filed on Sep. 5, 2006.

(30) Foreign Application Priority Data
Sep. 30, 2005 (JP) 2005-287546

(51) Int. Cl. G09G 3/34

(52) U.S. Cl. 345/107

(57) ABSTRACT

A display device allows a user to move displayed pages as the user actually reads a paper book. The display device includes an n-page forwarder for moving a displayed page forward by n pages (n is an arbitrary integer equal to or larger than 3), a one-page forwarder for moving a displayed page forward by one page, and a page backwarder for moving a displayed page backward either by (n/2) pages if “n” is an even number, or by {(n−1)/2} pages if “n” is an odd number.

### CROSS REFERENCE TO RELATED APPLICATIONS

This application claims priority from Japanese Patent Application No. 2005-287546 filed Sep. 30, 2005. This application is also a continuation-in-part of International Application No. PCT/JP2006/317536 filed Sep. 5, 2006 in Japan Patent Office as a Receiving Office. The contents of both applications are incorporated herein by reference.

### TECHNICAL FIELD

The present invention relates to a display device for displaying data on a page basis and switching displays by the page. The present invention also relates to a recording medium for storing a display program.

### BACKGROUND

A conventional display device displays a text file containing a plurality of pages on a page basis, such as an electronic book. Such a display device displays only one page at a time. The display device, therefore, switches one page displayed thereon to another.

Japanese Patent Application Publication No. 2001-60135 discloses a scroll display device capable of scrolling a text to be displayed thereon line by line. This scroll display device includes scrolling means for scrolling down one line, scrolling means for scrolling up one line, scrolling means for scrolling down eight lines, scrolling means for scrolling up eight lines, scrolling means for scrolling down a preset number of lines, and scrolling for scrolling up a preset number of lines up.

When a person reads or consults an actual paper book (for example, when searching a telephone book for a telephone number, or a dictionary for a word), the person has to know the order of the information arranged in the book. Therefore, the person turns the pages of the book, guessing which page includes the intended. Suppose that the person searches an English-Japanese dictionary for a word. Since words are arranged in the alphabetical order, the person turns the pages of the dictionary either forward or backward, guessing how many pages are left up to the page that contains the intended word from the present page.

In order to find the intended page, the person starts with turning the pages roughly. Since the person merely has a rough idea as to where the intended page is, the person often overshoots the intended page. When finding overshoot of the intended page, the person turns backward by a few pages. When the person has overshot the intended page backward again, the person approaches the intended page by turning a few pages further forward.

However, the conventional display device has not realized such human behaviors on turning pages.

### SUMMARY

The present invention is made in order to resolve the above problem, and it is an object of the present invention to provide a display device capable of moving displayed pages in accordance with actual human behaviors on reading a paper book.

According to one aspect of the invention, a display device includes a display panel, an n-page forwarder that moves a page displayed on the display panel forward by n pages (n being an integer equal to or larger than 3), a one-page forwarder that moves a page displayed on the display panel forward by one page, and a page backwarder that moves a page displayed on the display panel backward by (n/2) pages if n is an even number and by {(n−1)/21 pages if n is an odd number

According to another aspect of the invention, a display device includes a display panel, at least two page forwarders including a first page forwarder and a second page forwarder, and at least one page backwarder including a first page backwarder. The first page forwarder causes a page displayed on the display panel to move forward by a first preset number of pages, while the second page forwarder causes a page displayed on the display panel to move forward by a second preset number of pages. The first preset number of pages is different from the second preset number of pages. Likewise, the first page backwarder causes a page displayed on the display panel to move backward by a third preset number of pages. The first preset number of pages is equal to or larger than the third preset number of pages, and the second preset number of pages is equal to or smaller than the third preset number of pages.

According to further aspect of the invention, a recording medium stores a display program readable by a computer of a display device capable of displaying data and switching a displayed page to another on a page basis. The display program instructs an n-page forwarder to move a page displayed on a display panel forward by n pages (n is an integer equal to or larger than 3) when enabled by a user's operation, a one-page forwarder to move a page displayed on the display panel forward by one page when enabled by the user's operation, and a page backwarder to move a page displayed on the display panel backward either by (n/2) pages if n is an even number, or by {(n−1)/2} pages if n is an odd number, when enabled by the user's operation.

According to further aspect of the invention, a recording medium stores a display program readable by a computer of a display device capable of displaying data and switching a displayed page to another on a page basis. The display program instructs at least two page forwarders (including a first page forwarder and a second page forwarder) to move a page displayed on a display panel forward by a preset number of pages when enabled by a user's operation, and at least one page backwarder (including a first page backwarder) to move a page displayed on the display panel backward by a preset number of pages when enabled by the user's operation. The first page forwarder causes a page displayed on the display panel to move forward by a first preset number of pages, and the second page forwarder by a second preset number of pages. The first page backwarder causes a page displayed on the display panel to move backward by a third preset number of pages. The first preset number of pages is equal to or larger than the third preset number of pages, and the second preset number of pages is equal to or smaller than the third preset number of pages.

### BRIEF DESCRIPTION OF THE DRAWINGS

FIG. 1 is a perspective view showing the appearance of a display device 100 according to one embodiment of the present invention.

FIG. 2 is a block diagram of the display medium 100 according to one embodiment of the present invention.

FIG. 3 is a flowchart explaining the operations of a CPU 30 according to one embodiment of the present invention.

FIG. 4 is an explanatory diagram showing the operations of the display device 100 when a user wishes to find an intended page.

FIG. 5 is a comparative diagram to one embodiment of the present invention, explaining the operations of a display device equipped with a five-page skip key, a five-page back key, a one-page skip key, and a one-page back key, when a user wishes to find an intended page.

### DETAILED DESCRIPTION

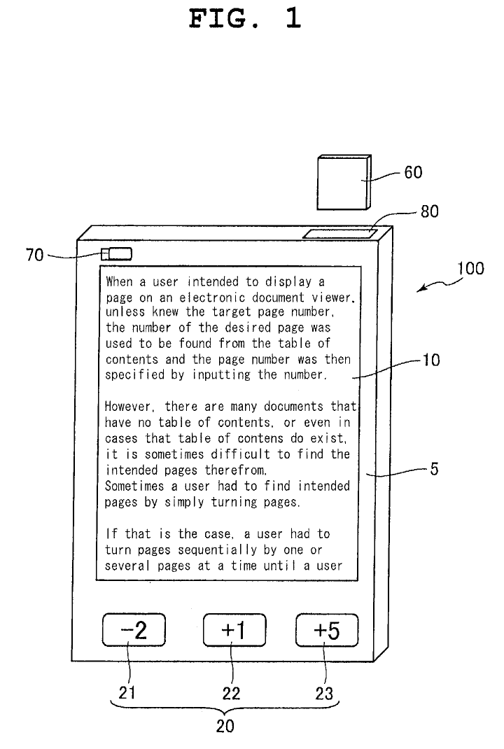

Hereinafter, preferred embodiments of the present invention will be described with reference to the accompanying drawings. FIG. 1 is a perspective view showing the appearance of a display device 100 according to the first embodiment of the present invention. As shown in FIG. 1, the display device 100 includes a display panel 10 for displaying text and/or an image thereon, a frame 5, a power switch 70, a slot 80, a two-page back key 21, a one-page skip key 22, and a five-page skip key 23.

The display panel 10 is configured of an electrophoretic display medium in which a display liquid with color-tinted charged particles dispersed therein is sealed between two glass substrates. In the display device 100, one surface of the paired glass substrates constituting the display panel 10 is exposed on the top face of the frame 5 and constitutes a display surface. An electrode (not shown) is provided on each of the glass substrates, and applying a voltage across the electrodes according to data types such as text data and various image data (to be described later) causes the charged particles in the display liquid to migrate. The charged particles having migrated to the display surface thus display images thereon. Since such an electrophoretic display medium has been well-known, as disclosed in Japanese Patent Application Publication No. 2004-13119, the description thereof is omitted here.

The frame 5 is a member surrounding the display panel 10, and a power switch 70, a two-page back key 21, a one-page skip key 22, and a five-page skip key 23 are provided on the top surface thereof.

The two-page back key 21, the one-page skip key 22, and the five-page skip key 23 are arranged on the lower side of the display panel 10 in the order of the two-page back key 21, the one-page skip key 22, and the five-page skip key 23 from the left.

The two-page back key 21 is a key for moving the page currently displayed backward by two pages. The one-page skip key 22 is a key for moving a page currently displayed forward by one page. The five-page skip key 23 is a key for moving the currently displayed page forward by five pages.

The power switch 70 is provided on the upper left side of the display panel 10. Sliding the power switch 70 starts to supply power to the display device 100.

As shown in FIG. 1, a slot 80 is provided on the right side of the upper side surface of the frame 5. The slot 80 is a slot for receiving a memory card 60 that stores a text data 61. The text data 61 is an electronic filing document containing data on the page basis.

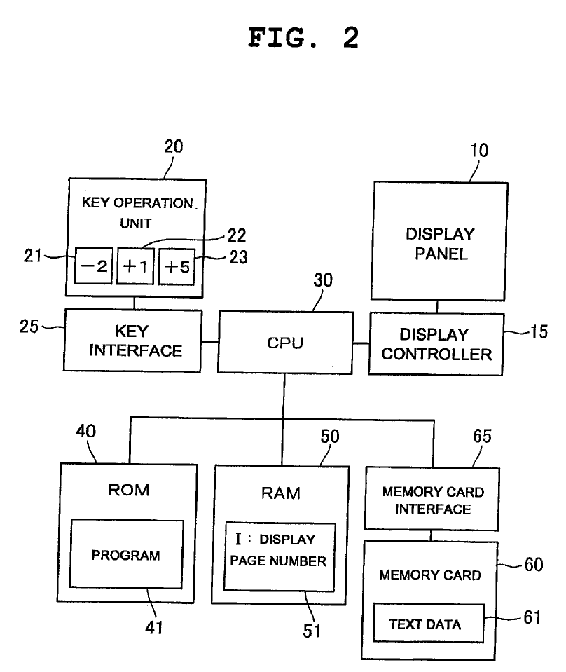

Next, the internal configuration of the display device 100 will be described with reference to a block diagram. FIG. 2 is a block diagram of the display device 100. As shown in FIG. 2, the display device 100 includes the display panel 10, a display controller 15, a key operation unit 20, a key interface 25, a CPU 30, a ROM 40, a RAM 50, and a memory card interface 65. The CPU 30 and the display controller 15 serve as a controller for the display device 100. Here, the two-page back key 21, the one-page skip key 22, and the five-page skip key 23 are collectively referred to as the key operation unit 20.

The ROM 40 stores a program 41 described later and is connected to the CPU 30. The RAM 50 includes a display page number storage area 51 for storing display page numbers described later, and is connected to the CPU 30. The memory card interface 65 is an interface for reading the text data 61 from the memory card 60 which has been inserted in the slot 80. The memory card interface 65 is connected to the CPU 30. The memory card 60 stores only one file of text data 61.

The key interface 25 is an interface for transmitting signals from the key operation unit 20 to the CPU 30. The key interface 25 is connected to the CPU 30.

The display controller 15 is connected to the CPU 30 to control the display panel 10 according to the instructions from the CPU 30.

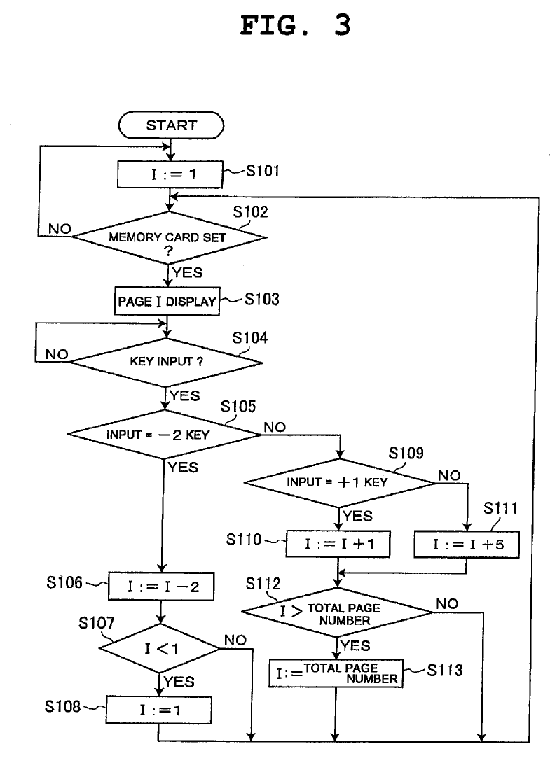

Next, the operation of the display device 100 will be described. FIG. 3 is a flowchart illustrating the process performed by the CPU 30 based on the program 41 stored in the ROM 40. Hereinafter, the operation of the display device 100 is described with reference to FIG. 3.

Supplying power to the display device 100 by operating the power switch 70 automatically starts the process. On the other hand, when the power switch 70 is slid to the other side, the display device 100 is turned off. Consequently, the power supply to the CPU 30 is ceased, terminating the process described later.

As the power is turned on, the CPU 30 starts processing and sets “1” as a variable I (S101). Here, the variable I indicates the page number of the electronic filing document displayed on the display panel 100. The value of the variable is stored in the display page number storage area 51 of the RAM 50.

Next, a determination is made as to whether or not the memory card 60 is inserted in the slot 80 (S102). If the memory card 60 is not inserted in the slot 80 (S102: NO), the process returns to S102 and waits until the memory card 60 is inserted.

If the memory card 60 is inserted in the slot 80 (S102: YES), the page I of the text data 61 stored in the memory card 60 is displayed on the display panel 10 (S103). Immediately after inserting the memory card 60 into the slot 80, the first page of data piece is displayed, since “1” is set as the variable I in S101.

Next, a judgment is made as to whether or not an input has been entered from the key operation unit 20 (S104). If no input has been entered from the key operation unit 20 (S104: NO), the process waits until an input is entered from the key operation unit 20.

When the input has been entered from the key operation unit 20 (S104: YES), a determination is made as to whether or not the input comes from the two-page back key 21 (S105).

If the input is from the two-page back key 21 (S105: YES), the value obtained by subtracting two from the present value of the variable I is set as the variable I (S106).

Next, a determination is made as to whether or not the variable I is smaller than “1” (S107). If the variable I is smaller than “1” (S107: YES), the value “1” is set as the variable I (S108). This is because the text data 61 has no page to be displayed before the first page. After that, the process returns to S102. If the memory card 60 is still inserted in the slot (S102: YES), the first page of the text data 61 is displayed in S103.

If the variable I is not smaller than “1” (S107: NO), the process returns to S102. If the memory card 60 is still in the slot (S102: YES), the page displayed is switched to the page located two-page behind.

If the two-page back key 21 is judged not to have been pressed in the key operation unit 20 in S105 (S105. NO), whether or not the one-page skip key 22 has been pressed in the key operation unit 20 is subsequently determined (S109).

If the input from the key operation unit 20 comes from the one-page skip key 22 (S109: YES), the value added one to the present value of the variable I is set as the variable I (S110). Next, whether or not the value of the variable I is larger than the total page number of the text data 61 (the last page number) is determined (S112).

If the value of the variable I is larger than the total page number of the text data 61 (S112: YES), the total page number of the text data 61 is set as the variable I (S113). This is because the text data 61 has no page to be displayed after the last page. After that, the process returns to S102. If the memory card 60 is still in the slot (S102: YES), the last page of the text data 61 is displayed in S103.

If the value of the variable I is not larger than the total page number of the text data 61 in S112 (S112: NO), the displayed page switches to the page located one-page ahead in S103.

Alternatively, if the input from the key operation unit 20 does not come from the one-page skip key 22 in S109 (109: NO), the value added five to the present value of the variable I is set as the variable I (S311). This is because NO in S109 means the input from the key operation unit 20 comes from the five-page skip key 23.

After that, the process moves on to S112. Likewise as described above, if the value of the variable I is larger than the total page number of the text data 61 (S112: YES), the last page of the text data 61 is displayed in S103. If the value of the variable I is not larger than the total page number of the text data 61 (S112: NO), the displayed page switches to the page located five-page ahead in S103.

The process returns to S101 if NO in S102 so that the first page is to be displayed in cases that the memory card 60 is removed halfway or another memory card 60 is inserted.

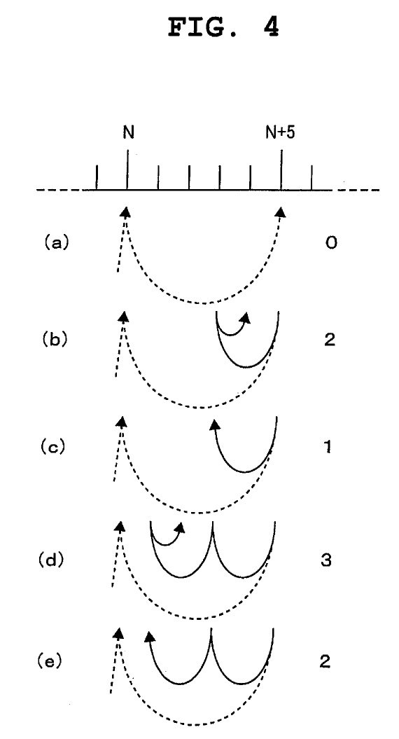

FIG. 4 is shows operations of the display device 100 so that a user finds the intended page in the text data 61. Here, suppose that the N-th page of the text data 61 is being displayed on the display device 100. The number “N” may be arbitrary.

FIG. 4(a) shows an operation in which an intended page is located N+5 pages ahead of the present page. FIG. 4(b) shows an operation in which an intended page is located N+4 pages ahead of the present page. FIG. 4(c) shows an operation in which an intended page is located N+3 pages ahead of the present page. FIG. 4(d) shows an operation in which an intended page is located N+2 pages ahead of the present page. FIG. 4(e) shows an operation in which an intended page is located N+1 pages ahead of the present page.

If the intended page is located N+5 pages ahead, depressing the five-page skip key 23 once enables the user to find the intended page.

If the intended page is located N+4 pages ahead, depressing the five-page skip key 23 once leads the user to the N+5-th page. When the user recognizes the intended page is located slightly behind the N+5-th page, the user then depresses the two-page back key 21 once to open the N+3-th page. Now that the use realizes the intended page is located slightly ahead of the N+3-th page, the user depresses the one-page skip key 22 once to find the intended page.

If the intended page is located N+3 pages ahead, the user depresses the five-page skip key 23 once to open the N+5-th page. Since the intended page is behind the N+5-th page, the user depresses the two-page back key 21 once time to reach the intended page.

If the intended page is located N+2 pages ahead, the user depresses the five-page skip key 23 once to open the N+5-th page. Since the intended page is behind the N+5-th page, the user depresses the two-page back key 21 once to reach the N+3-th page. Since the intended page is behind the N+3-th page, the user depresses the two-page back key 21 once again to reach the N+1-th page. Since the intended page is ahead of the N+1-th page, the user depresses the one-page skip key 22 once to reach the N+2-th page.

If the intended page is located N+1 pages ahead, the user depresses the five-page skip key 23 once to open the N+5-th page. Since the intended page is behind the N+5-th page, the user depresses the two-page back key 21 once to reach the N+3-th page. Since the intended page is behind the N+3-th page, the user depresses the two-page back key 21 once more to reach the intended page.

The display device 100, which thus includes the two-page back key 21, the one-page skip key 22, and the five-page skip key 23, allows a user to turn pages as the user actually reads a paper book.

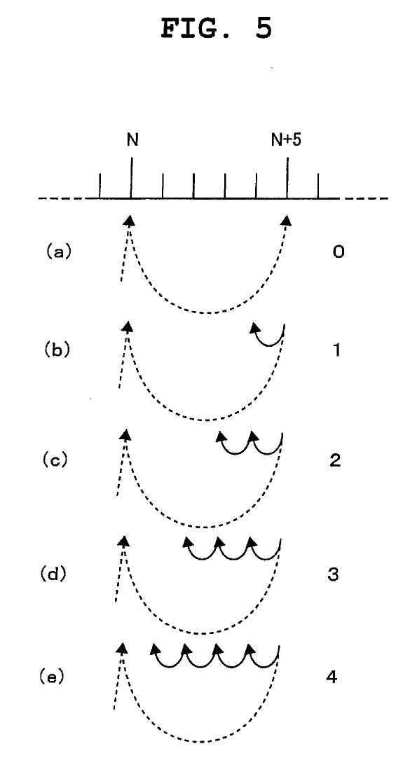

Next, as a comparative example, a display device which includes a five-page skip key, a five-page back key, a one-page skip key and a one-page back key will be described. In the display device, a user performs the following operations to reach the intended page. FIG. 5 shows the operations in this example.

FIG. 5(a) shows an operation in which an intended page is located N+5 pages ahead of the present page. FIG. 5(b) shows an operation in which an intended page is located N+4 pages ahead of the present page. FIG. 5(c) shows an operation in which an intended page is located N+3 pages ahead of the present page. FIG. 5(d) shows an operation in which an intended page is located N+2 pages ahead of the present page. FIG. 5(e) shows an operation in which an intended page is located N+1 pages ahead of the present page.

If the intended page is located N+5 pages ahead, depressing the five-page skip key once enables the user to find the intended page.

If the intended page is located N+4 pages ahead, depressing the five-page skip key 23 once leads the user to the N+5-th page. When the user recognizes the intended page is located slightly behind the N+5-th page, the user then depresses the one-page back key 21 once to find the intended page.

If the intended page is located N+3 pages ahead, the user depresses the five-page skip key 23 once to open the N+5-th page. Since the intended page is behind the N+5-th page, the user depresses the one-page back key 21 twice to reach the intended page.

If the intended page is located N+2 pages ahead, the user depresses the five-page skip key 23 once to open the N+5-th page. Since the intended page is behind the N+5 page, the user depresses the one-page back key three times to reach the intended page.

If the intended page is located N+1 pages ahead, the user depresses the five-page skip key 23 once to open the N+5-th page. Since the intended page is behind the N+5-th page, the user depresses the one-page back key four times to reach the intended page.

As described above, the display device, which includes the five-page skip key, the five-page back key, the one-page skip key, and the one-page back key, does not allows a user to turn pages as the user actually reads a paper book.

In the embodiment, the display device 100 includes the two-page back key 21, the one-page skip key 22, and the five-page skip key 23. However, instead of these keys, a three-page back key for moving the displayed page backward by three pages, a one-page skip key for moving the displayed page forward by one page, and a six-page skip key for moving the displayed page forward by six pages may be provided.

If there are provided an n-page skip key (n is an arbitrary integer equal to or larger than 3), a one-page skip key, and an (n/2)-page back key (if “n” is an even number) or an {(n−1)/2}-page back key (if “n” is an odd number), the combination of these three keys provides the easiest way for a user to find an intended page, since the user can depress the keys for the least number of times on average to reach the intended page.

Although the present invention has been described with respect to a specific embodiment, it will be apparent by one skilled in the art that a variety of changes and modifications may be made without departing from the scope of the invention. For example, the display device 100 may include at least two page skip keys (for a descriptive purpose, to be referred to as a first page skip key and a second page skip key) and at least one page back key (to be called a first page back key for the same reason). Each of the page skip keys enables a page displayed on the display panel 10 to move forward by a first preset number of pages in case of depressing the first page skip key, and by a second preset number of pages in case of depressing the second page skip key, respectively. The first page back key enables the page displayed on the display panel 10 to move backward by a third preset number of pages when depressed. In this case, the first preset number of pages is different from the second preset number of pages. Further, the first preset number of pages is equal to or larger than the third preset number of pages, while the second preset number of pages is equal to or smaller than the third preset number of pages. The display device described as above allows a user to move a displayed page as the user actually reads a paper book.

What is claimed is:

1. A display device comprising:
a display panel;
an n-page forwarder that moves a page displayed on the display panel forward by n pages, n being an integer equal to or larger than 3;
a one-page forwarder that moves a page displayed on the display panel forward by one page; and
a page backwarder that moves a page displayed on the display panel backward by (n/2) pages if n is an even number and by {(n−1)/2} pages if n is an odd number.

2. The display device according to claim 1, wherein the display panel comprises an electrophoretic display medium, the electrophoretic display medium having first and second substrates disposed in opposition to each other and a dispersion medium with dispersed charged particles interposed therebetween.

3. The display device according to claim 1, further comprising:
a memory having a display page number storage area for storing a display page number; and
a controller that is connected to the memory and controls the display panel,
wherein each of the n-page forwarder, the onepage forwarder, and the page backwarder is enabled when operated by a user, the n-page forwarder producing an output instructing the page displayed on the display panel to move forward by n pages when the n-page forwarder is enabled, the one-page forwarder instructing the page displayed on the display panel to move forward by one page when the one-page forwarder is enabled, and the page backwarder instructing the page displayed on the display panel to move backward by (n/2) pages if n is an even number and by {(n−1)/2} pages if n is an odd number when the page backwarder is enabled, and wherein the controller controls the display panel to display a target page based on the page number stored in the memory and the outputs from the n-page forwarder, the one-page forwarder, and the page backwarder.

4. A display device comprising:
a display panel;
at least two page forwarders including a first page forwarder and a second page forwarder, the first page forwarder causing a page displayed on the display panel to move forward by a first preset number of pages, the second page forwarder causing a page displayed on the display panel to move forward by a second preset number of pages, the first preset number of pages being different from the second preset number of pages; and
at least one page backwarder including a first page backwarder that causes a page displayed on the display panel to move backward by a third preset number of pages,
wherein the first preset number of pages is equal to or larger than the third preset number of pages, and the second preset number of pages is equal to or smaller than the third preset number of pages.

5. The display device according to claim 4, wherein the third preset number of pages is equal to or smaller than a half of a sum of the first preset number of pages and the second preset number of pages.

6. The display device according to claim 5, wherein the first preset number of pages is n, n being an integer equal to or larger than 3, the second preset number of pages is one, and the third preset number of pages is (n/2) if n is an even number and {(n−1)/2} if n is an odd number.

7. The display device according to claim 4, wherein a number of the page backwarders is smaller than a number of the page forwarders.

8. The display device according to claim 7, wherein the number of the page forwarders is two, and the number of the page backwarders is one.

9. A recording medium storing a display program readable by a computer of a display device capable of displaying data and switching a displayed page to another on a page basis, the display program comprising:
instructing an n-page forwarder to move a page displayed on a display panel forward by n pages (n is an integer equal to or larger than 3), when enabled by a user's operation;
instructing a one-page forwarder to move a page displayed on the display panel forward by one page when enabled by the user's operation; and
instructing a page backwarder to move a page displayed on the display panel backward either by (n/2) pages if n is an even number, or by {(n−1)/2} pages if n is an odd number, when enabled by the user's operation.

10. A recording medium storing a display program readable by a computer of a display device capable of displaying data and switching a displayed page to another on a page basis, a display program comprising:
instructing at least two page forwarders, including a first page forwarder and a second page forwarder, to move a page displayed on a display panel forward by a preset number of pages when enabled by a user's operation, the first page forwarder causing a page displayed on the display panel to move forward by a first preset number of pages, the second page forwarder causing a page displayed on the display panel to move forward by a second preset number of pages, the first preset number of pages being different from the second preset number of pages; and
instructing at least one page backwarder, including a first page backwarder, to move a page displayed on the display panel backward by a preset number of pages when enabled by the user's operation, the first page backwarder causing a page displayed on the display panel to move backward by a third preset number of pages,
wherein the first preset number of pages is equal to or larger than the third preset number of pages, and the second preset number of pages is equal to or smaller than the third preset number of pages.
